(19) United States
(12) Patent Application Publication
(10) Pub. No.: US 2007/0270558 A1
(43) Pub. Date: Nov. 22, 2007

(54) Pulsing olefin polymerization fluidized-bed reactors

(76) Inventors: Paul Keith Scherrer, Johnson City, TN (US); Guy Glen Luneau, Solgohachia, AR (US); Kenneth Alan Dooley, Longview, TX (US)

Correspondence Address: BUCHANAN, INGERSOLL & ROONEY, PC, P.O. BOX 1404, ALEXANDRIA, VA, 22313-1404, US

(21) Appl. No.: 11/585,051

(22) Filed: Oct. 23, 2006

Related U.S. Application Data
(60) Provisional application No. 60/800,826, filed on May 16, 2006.

(51) Int. Cl. C08F 2/00

(52) U.S. Cl. 526/88; 526/64; 526/74; 526/901

(57) ABSTRACT

A method of preventing or inhibiting fouling in an olefin polymerization fluidized-bed reactor is provided. The method involves varying the fluidization velocity inside the reactor over time about a set point.

### CROSS-REFERENCE TO RELATED APPLICATION

This application claims the benefit of U.S. Provisional Patent Application No. 60/800,826, filed May 16, 2006.

### FIELD OF THE INVENTION

The invention generally relates to a method for preventing or inhibiting fouling in an olefin polymerization fluidized-bed reactor.

### BACKGROUND OF THE INVENTION

In olefin polymerization fluidized-bed reactors, fluidization is achieved by means of upward flowing gas. A grid at the bottom of the reactor is used to uniformly distribute the fluidization gas across the reactor cross-section and to prevent solids from entering the gas supply plenum. A problem plaguing the industry is the build-up of sheets of powder on the wall of the reactor. When these sheets fall from the reactor wall, they have the potential of blocking significant portions of the gas distribution grid and, as a result, disrupt the reactor flow or even plug the reactor.

Thus, there is a need in the art for a means of altering the hydrodynamics of the olefin polymerization fluidized bed to reduce the sheeting potential and improve mixing.

### SUMMARY OF THE INVENTION

Briefly, the present invention provides a method for preventing or inhibiting fouling in an olefin polymerization fluidized-bed reactor. The method involves periodically changing the fluidization velocity inside the reactor.

### DETAILED DESCRIPTION OF THE INVENTION

During operation, the fluidization velocity in commercial olefin polymerization fluidized-bed reactors is typically maintained at a set point. According to the invention, sheeting in such reactors can be decreased or prevented by altering the hydrodynamics of the fluidized bed while still maintaining turbulent fluidization. The present invention accomplishes this result by periodically changing the fluidization velocity inside the reactor during operation.

By “periodically,” it is meant that the fluidization velocity inside the reactor is changed once every 0.1 second to 4 hours. The frequency of the fluidization velocity change can vary, depending on the particular system employed. But for many systems, the typical frequency of the change can be once every 0.5 to 30 minutes.

The degree of the change in the fluidization velocity can also vary, depending on the particular system employed. But typically, the fluidization velocity can be changed anywhere from ±1 to ±50% of the previous fluidization velocity value. More typically, the fluidization velocity is changed anywhere from ±5 to ±10% of the previous fluidization value.

It is noted that some polymerization systems may have variability in the measured fluidization velocity without any intentional changes. This variability may be caused by the variability in the compressor(s) and/or detection equipment employed. But such variation is typically less than ±1% of the set fluidization value and would not significantly reduce or inhibit fouling.

The fluidization velocity can be changed according to the invention in a sinusoidal or step-wise manner or a combination of both.

The fluidization velocity inside the reactor is usually between about 0.2 and about 4 feet/second. The fluidization velocity therefore can be varied anywhere between these values.

The method of the invention can be applied to any fluidized-bed, olefin polymerization process that is susceptible to fouling or sheeting in the fluidized-bed polymerization reactor. Suitable polymerization monomers include olefins such as ethylene, propylene, butene, pentene, hexene, etc. and combinations thereof.

The manner in which the fluidization velocity inside the reactor is periodically changed is not particularly limiting. For example, the fluidization velocity can be changed by periodically changing the volumetric flow rate of the feed stream to the reactor. With a centrifugal compressor, for example, the inlet guide vanes can be adjusted by means of an actuator to vary the gas flow rate. Alternatively, the feed to the reactor could be periodically changed by directing differing amounts of the feed stream into a bypass line around the reactor.

The fluidization velocity inside the reactor can also be changed by periodically decreasing the pressure inside the reactor, such as by opening a vent at the top of the reactor.

The fluidization velocity inside the reactor can also be changed by introducing an additional fluid into the reactor. This fluid can be a liquid or a gas, and can be a diluent or a mixture of feed gas ingredients. Suitable diluents include, for example, nitrogen, hydrogen, olefins, and alkanes. Preferably, the fluid is introduced below the distribution grid so that it can be evenly distributed into the fluidization bed.

The invention has been described in detail with particular reference to preferred embodiments thereof, but it will be understood that variations and modifications can be effected within the spirit and scope of the invention.

We claim:

1. A method for preventing or inhibiting fouling in an olefin polymerization fluidized-bed reactor, comprising:
periodically changing the fluidization velocity inside the reactor during operation.

2. The method according claim 1, wherein the changing step comprises changing the volumetric flow rate of a feed stream to the reactor.

3. The method according to claim 1, wherein the changing step comprises introducing an additional fluid into the reactor.

4. The method according to claim 1, wherein the changing step comprises decreasing pressure inside the reactor.

5. A method for preventing or inhibiting fouling in an olefin polymerization fluidized-bed reactor, comprising:
periodically changing the fluidization velocity inside the reactor in a sinusoidal manner.

6. A method for preventing or inhibiting fouling in an olefin polymerization fluidized-bed reactor, comprising:
periodically changing the fluidization velocity inside the reactor in a step-wise manner.

7. The method according to claim 1, wherein the fluidization velocity is changed every 0.5 to 30 minutes.

8. The method according to claim 1, wherein the fluidization velocity is varied between 0.2 and 4 feet/second.

9. The method according to claim 1, wherein the fluidization velocity is changed from ±1 to ±50% of its previous value.

10. The method according to claim 1, wherein the fluidization velocity is changed from ±5 to ±10% of its previous value.
